(19) United States
(12) Patent Application Publication
(10) Pub. No.: US 2018/0173426 A1
(43) Pub. Date: Jun. 21, 2018

(54) OBTAINING BIDDING FOR VOLUMES IN A STORAGE AREA NETWORK

(71) Applicant: Lenovo Enterprise Solutions (Singapore) Pte. Ltd., Singapore (SG)

(72) Inventors: Michael N. Condict, Hurdle Mills, NC (US); Jonathan R. Hinkle, Raleigh, NC (US)

(21) Appl. No.: 15/384,463

(22) Filed: Dec. 20, 2016

(51) Int. Cl. G06F 3/06

(52) U.S. Cl. CPC G06F 3/0608; G06F 3/067; G06F 3/0659; G06F 3/0631

(57) ABSTRACT

A method, apparatus and computer program product are provided. For example, a computer program product may include a computer readable storage medium that is not a transitory signal having program instructions embodied therewith, the program instructions executable by a processor to: receive a bid request from a storage manager, wherein the bid request identifies a volume parameter of a volume to be created; determine a bid based on the current capacity of a data storage device to host the identified volume; and send the bid to the storage manager.

### BACKGROUND

The present disclosure relates to a storage area network having a plurality of data storage devices.

### BACKGROUND OF THE RELATED ART

A storage area network (SAN) is a network that provides multiple servers with block-level access to data storage devices that appear to the operating systems of those servers as if the data storage devices are directly attached to the respective server. In a conventional SAN that is implemented with passive hard disk drives attached to a storage controller via SATA or SAS, a storage management system controls volume migration or provisioning on each of the drives within the SAN.

In order to determine which drive should receive migration of an existing volume or receive a volume to be newly provisioned, the storage management system must maintain current information about a number of input/output operations per second (IOPS) and an amount of unused (free) data storage space on each drive in the SAN. The storage management system then uses this data in some way to select a drive to receive and host the volume.

### BRIEF SUMMARY

One embodiment provides a computer program product comprising computer readable storage media that is not a transitory signal having program instructions embodied therewith, wherein the program instructions are executable by a processor to: receive a bid request from a storage manager, wherein the bid request identifies a volume parameter of a volume to be created; determine a bid based on the current capacity of a data storage device to host the identified volume; and send the bid to the storage manager.

Another embodiment provides an apparatus comprising at least one storage device for storing program instructions, and at least one processor for processing the program instructions to: receive a bid request from a storage manager, wherein the bid request identifies a volume parameter of a volume to be created; determine a bid based on the current capacity of a data storage device to host the identified volume; and send the bid to the storage manager.

Yet another embodiment provides a computer program product comprising computer readable storage media that is not a transitory signal having program instructions embodied therewith, wherein the program instructions are executable by a processor to: send a bid request to a plurality of data storage devices in a storage area network, wherein the bid request identifies a volume parameter of a volume to be created; obtain a bid from two or more of the data storage devices; select one of the data storage devices based on the bids obtained; and instruct the selected data storage device to create a volume having the volume parameter.

### BRIEF DESCRIPTION OF THE SEVERAL VIEWS OF THE DRAWINGS

FIG. 1 is a diagram of a computer system including a storage area network having a plurality of programmable data storage devices.

FIG. 2 is a diagram of a computer that may be used to implement the storage management server.

FIG. 3 is a flowchart of a method according to one embodiment.

FIG. 4 is a flowchart of method according to another embodiment.

### DETAILED DESCRIPTION

One embodiment provides a computer program product comprising computer readable storage media that is not a transitory signal having program instructions embodied therewith, wherein the program instructions are executable by a processor to: receive a bid request from a storage manager, wherein the bid request identifies a volume parameter of a volume to be created; determine a bid based on the current capacity of a data storage device to host the identified volume; and send the bid to the storage manager.

The processor may be part of a data storage device. For example, a data storage device may have a processor that executes program instructions to determine a bid as a function of one or more of an amount of available data storage capacity within the programmable data storage device and an input/output load on the programmable data storage device. Optionally, the bid may be a numerical value in a predetermined range. Additional program instructions may be processed by the processor to perform additional actions according to one or more embodiments. Still further, the data storage device will also include data storage media, such as a hard disk drive, solid state drive, optical disk drive or any other data storage media.

The data storage device may have access to an amount of available capacity of the data storage device, or be able to determine the amount of available capacity based on a known total capacity of the data storage device and an amount of the capacity that is in use. In addition, the data storage device may be able to monitor an input/output load on the data storage device.

A storage management system, such as a server or dedicated controller, may also include a processor for executing program instructions to perform the functions and responsibilities of managing a plurality of data storage devices. Additional program instructions may be processed by the storage management system to perform additional actions according to one or more embodiments. For example, the storage management system may send a bid request to a plurality of data storage devices in a storage area network, wherein the bid request identifies a volume parameter of a volume to be created; obtain a bid from two or more of the data storage devices; select one of the data storage devices based on the bids obtained; and instruct the selected data storage device to create a volume having the volume parameter.

In one option, the storage management system may select one of the data storage devices based on the obtained bids in response to obtaining a bid from each of the plurality of data storage devices to which a bid request was sent. However, there is a possibility that a programmable data storage device will go off line, fail, or otherwise be unable to respond with a bid. Accordingly, in another option, the storage management system may select one of the data storage devices based on the obtained bids in response to expiration of a predetermined time period following sending the bid request to the plurality of data storage devices.

After the selected data storage device has created the volume, the storage management system may provide an instruction to migrate an existing volume to the selected data storage device from another of the data storage devices, or provision a new volume to the selected programmable data storage device. For example, the storage management system may have detected a load imbalance between first and second data storage devices. Load may, without limitation, be measured in terms of a number of I/O operations per unit time directed at a given data storage device, an average bandwidth to and from a given data storage device, or other similar measures. In order to reduce the load imbalance, the storage management server may identify a first data storage device and a volume on the first data storage device, and identify a second data storage device that has submitted the highest bid to receive and host the volume. Using load data for each data storage device and/or each volume on each data storage device, the storage management server may identify a volume that, if migrated to an identified data storage device, would reduce the load imbalance. Still further, if a host device needs a new volume, the storage management system may obtain bids, wherein the best bid is used to select one of the data storage devices having sufficient available load and storage capacity to receive and host the new volume.

In a further embodiment, each of the plurality of data storage devices may determine the bid as a further function of a load on a central processing unit of the programmable data storage device. This embodiment recognizes that the central processing unit of a data storage device may be performing such a high load of program instructions that it affects the throughput of the data storage device. Optionally, the bids may be determined as a function of both the amount of available data storage capacity within the data storage device and the input/output load on the programmable data storage device, and as a further function of a load on a central processing unit of the data storage device.

In a still further embodiment, the bid request may further identify a quality of service (QoS) parameter that each data storage device should use in a formula for determining a bid. The QoS parameter may be applied to the existing load and volumes of the data storage device and/or the volume to be migrated or provisioned to the data storage device.

Embodiments of the present invention may select a data storage device to create, receive and host a new or existing volume. The data storage device forms a bid that may consider one or more factors including balancing IOPs (IO operations per second), storage capacity, and CPU usage. The factors, weightings and algorithms used to determine a bid may vary widely, but it is preferred that each data storage device use the same algorithm or methodology so that the bids are prepared on the same basis and can be used to accurately load balance the data storage devices. These conditions can change rapidly for each data storage device in a distributed storage system, thereby making it inefficient to make optimal decisions from centralized management. The present embodiments may implement an auction-style algorithm among the data storage devices, which prevents the storage management system from having to keep up-to-date information about the current resource usage of each data storage device. Rather, the new volume is assigned to the data storage device that submits the best bid. Optionally, the best bid may be the highest bid.

A bid for a given data storage device, which may be considered to be a score representing the desirability of the particular data storage device hosting the volume, may be determined on the basis of one or more factors, such as a measure of an operation load on the data storage device, and a measure of the free storage capacity on the data storage device. If the data storage device is currently doing so many I/O operations per second that the data storage device can't take on any additional I/O operations without slowing down the servicing of the existing I/O operations, then the data storage device should have a low desirability as a host for the volume. If the data storage device has less free space than the desired size of the volume, then the data storage device cannot host the volume.

In one embodiment, the bid may be a numerical value in a predetermined range, such as a range from 0 to 100. Optionally, a higher bid may mean that the programmable data storage device is more desirable to host the new volume, and a bid of zero means that the data storage device cannot host the new volume. Each data storage device then replies to the storage management system with its bid. When the storage management system has received all the bids (or after a fixed timeout, in case some of the data storage devices fail or do not return a bid), the storage management system will send a volume creation request to the data storage device which returned the highest bid. If multiple data storage devices returned the same highest bid, the storage management system may select one of the highest bidding data storage devices at random. If none of the data storage devices return a non-zero bid, then the new volume creation will fail.

A further embodiment provides a formula for determining a bid (desirability score) between 0 and 100 for a given data storage device, as follows:

Let IOPS_MAX=the maximum number of I/O operations per second for the data storage device;
Let IOPS_CURR=the current number of I/O operations per second that the data storage device is handling (optionally averaged over a trailing time period, such as the last minute);
Let CAPACITY=the full size of the data storage device (measured in GB); and
Let FREE_SPACE=the amount of the data storage device that is not already in use by existing volumes (measured in GB).

BID=(FREE_SPACE/CAPACITY)*(IOPS_MAX−IOPS_CURR)/IOPS_MAX*100

The first and second parenthesis produce a fraction less than or equal to 1, and the product of the two parenthetical values is also a fraction less than or equal to 1. Therefore, multiplying the product by 100 produces a number between 0 and 100.

According to the foregoing formula, the desirability score for a data storage device will be 0 when there is no FREE_SPACE on the data storage device (FREE_SPACE=0), and the desirability score for the data storage device will also be 0 when the data storage device is already operating at maximum IOPS (IOPS_CURR=IOPS_MAX). In both of these circumstances, the relevant data storage device is clearly not able to host another volume. Conversely, if the data storage device is currently empty (FREE_SPACE=CAPACITY) and the data storage device also is doing no IOPS (IOPS_CURR=0), then the desirability score for the data storage device will have the maximum value of 100.

The previously stated formula may be restated as follows:

BID=((TOTAL CAPACITY−CURR. USED CAPACITY)/TOTAL CAPACITY)* ((MAXIMUM IOPS−CURR. USED IOPS)/MAXIMUM IOPS)*100

Furthermore, in embodiments where a quality of server (QoS) parameter is provided, the bid may be determined in view of the QoS parameter. For example, if a QoS parameter is provided that guarantees a certain amount of storage capacity or a certain amount of IOPS, these “currently allocated” amounts may be used in the formula rather than the “currently used” amounts. Accordingly, the formula for calculating a bid may be revised to the following:

BID=((TOTAL CAP.−CURRENTLY ALLOCATED CAP.)/TOTAL CAP.)* ((MAX. IOPS−CURRENTLY ALLOCATED IOPS)/MAX. IOPS)*100

Another embodiment provides a computer program product comprising computer readable storage media that is not a transitory signal having program instructions embodied therewith, wherein the program instructions are executable by a processor to: send a bid request to a plurality of data storage devices in a storage area network, wherein the bid request identifies a volume parameter of a volume to be created; obtain a bid from two or more of the data storage devices; select one of the data storage devices based on the bids obtained; and instruct the selected data storage device to create a volume having the volume parameter. The foregoing computer program products may include program instructions further executable by the processor for implementing or initiating any one or more of the embodiments described herein.

Yet another embodiment provides an apparatus comprising at least one storage device for storing program instructions, and at least one processor for processing the program instructions to: receive a bid request from a storage manager, wherein the bid request identifies a volume parameter of a volume to be created; determine a bid based on the current capacity of a data storage device to host the identified volume; and send the bid to the storage manager. The foregoing apparatus may further process the program instructions to implement or initiate any one or more of the embodiments described herein.

A still further embodiment provides a system comprising a plurality of programmable data storage devices in a storage area network, at least one storage device for storing program instructions, and at least one processor for processing the program instructions to: send a bid request to the plurality of data storage devices, wherein the bid request identifies a volume size of a volume to be created; obtain a bid from two or more of the plurality of data storage devices determined as a function of one or more of an amount of available data storage capacity within the data storage device and an input/output load on the data storage device; select one of the data storage devices based on the bids obtained; and instruct the selected data storage device to create a volume having the volume size. The foregoing system may further process the program instructions to implement or initiate any one or more of the embodiments described herein.

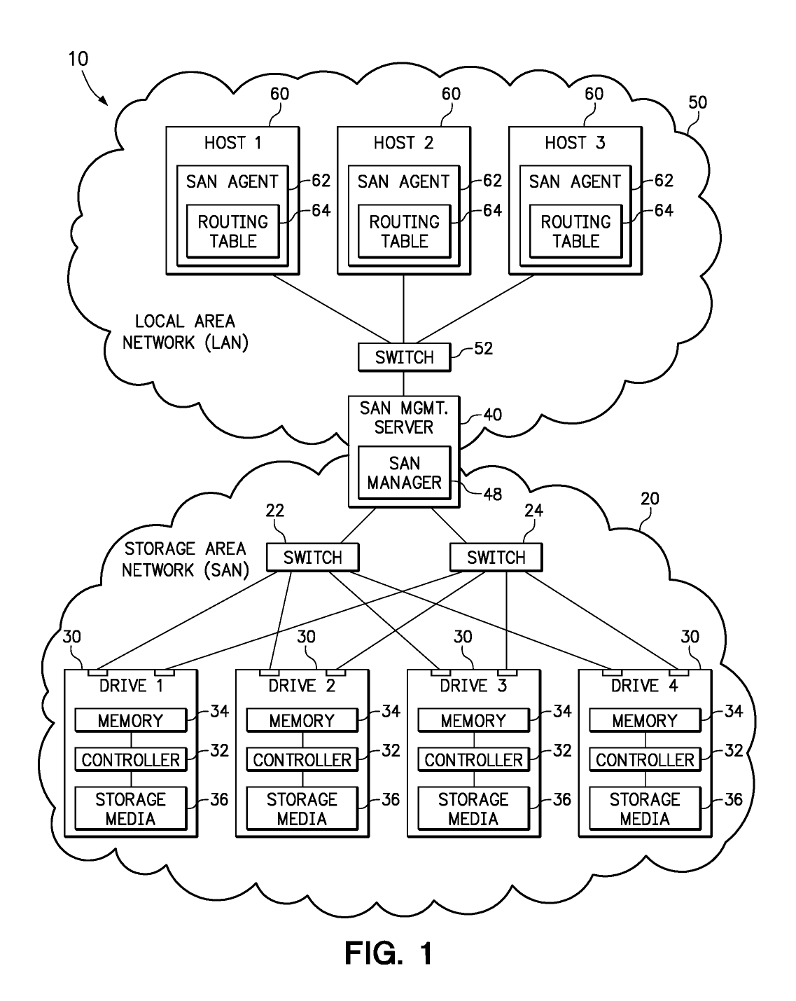

FIG. 1 is a diagram of a computer system 10 including a storage area network 20 having a plurality of programmable data storage devices 30. A storage area network (SAN) management server 40 is part of the storage area network 20, but is also included in a local area network (LAN) 50 including a plurality of host devices 60. The computer system 10 facilitates any of the host devices 60 providing I/O operations to any of the programmable data storage devices 30, which may be hard disk drives, solid state drives, optical disks, other types of programmable data storage devices, and combinations thereof.

Each host device 60 includes a SAN agent 62, which may be embodied in software, which routes I/O operations to the appropriate volumes stored on the appropriate programmable data storage device 30. For this purpose, the SAN agent 62 may include a routing table 64 that points to a volume on a given programmable data storage device 30 where certain files are being stored. The SAN agent 62 may be loaded at a low level that is not visible to applications on the host device 60 that are using the SAN 20. A switch 52 may be provided for enabling communication among the host devices 60 and the storage management server 40.

Each programmable data storage device 30 may include a programmable controller 32, memory 34, and storage media 36, such as a hard disk or a solid state drive. Bidding logic may be stored on the storage media and loaded into memory for execution by the programmable controller 32, which may include a processor that executes the bidding logic enabling the programmable data storage device 30 to perform steps consistent with method embodiments of the present invention. In this illustration, the storage area network 20 includes a first switch 22 and a second switch 24 for enabling communication among the programmable data storage devices 30 and the storage management server 40, but other storage area network configurations may also be used.

In various embodiments, the storage management server 40 may detect an imbalance in storage capacity utilization or I/O operation load among the programmable data storage devices 30, or determine a need to provision a new volume on one of the programmable data storage devices 30 based on a demand of one of the host devices 60. In either situation, the SAN manager 48 running on the storage management server 40 may generate and broadcast a bid request to each of the programmable data storage devices 30. Because each programmable data storage device 30 determines their own bid, the SAN manager 48 does not need to monitor current operational data for each of the devices 30 and the amount of network traffic on the SAN 20 is reduced. The SAN manager 48 then obtains the bids, identifies which programmable data storage device 30 has submitted the highest bid, and instructs the identified programmable data storage device to create the volume. The SAN manager 48 will then modify a routing table or inform a host device where to access the newly created volume.

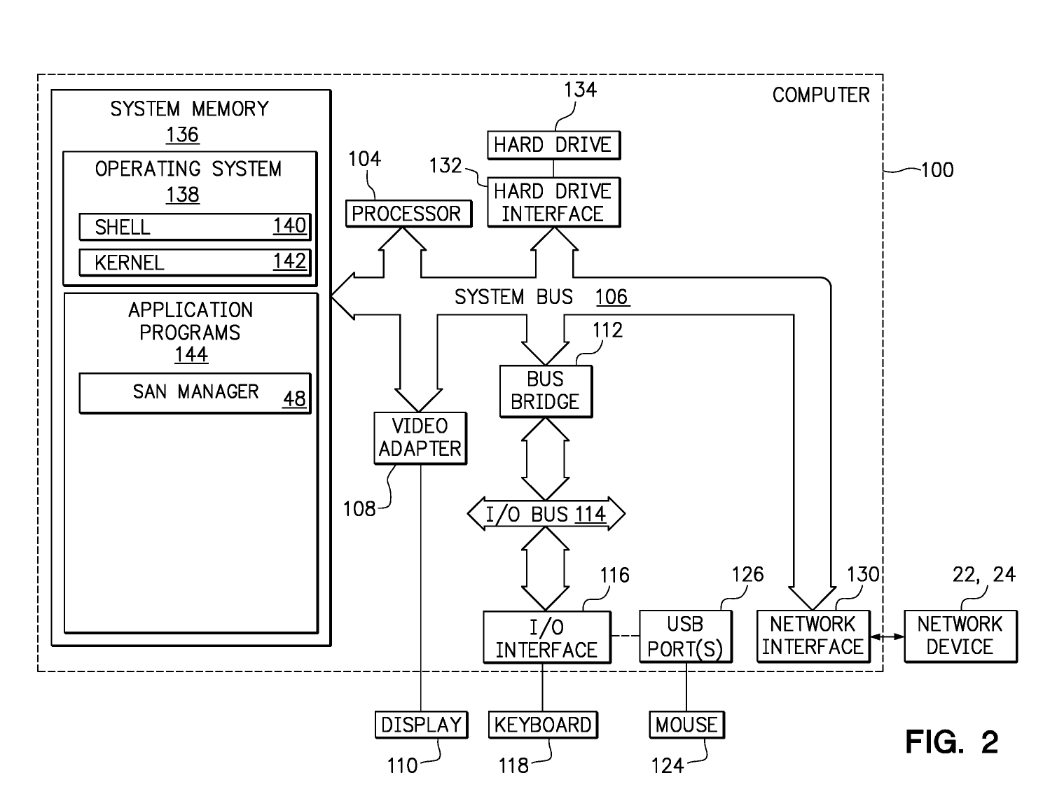

FIG. 2 is a diagram of a computer 100 that is representative of the storage management server 40 according to one or more embodiment of the present invention. Furthermore, the computer 100 may be representative of a host device 60 but with the SAN agent application (program instructions) 62 replacing the SAN manager software (program instructions) 48.

The computer 100 includes a processor unit 104 that is coupled to a system bus 106. The processor unit 104 may utilize one or more processors, each of which has one or more processor cores. A video adapter 108, which drives/supports a display 110, is also coupled to system bus 106. The system bus 106 is coupled via a bus bridge 112 to an input/output (I/O) bus 114. An I/O interface 116 is coupled to the I/O bus 114. The I/O interface 116 affords communication with various I/O devices, including a keyboard 118, and a USB mouse 124 via USB port(s) 126. As depicted, the computer 100 is able to communicate with a network device, such as one of the switches 22, 24 (see FIG. 1) using a network adapter or network interface controller 130.

A hard drive interface 132 is also coupled to the system bus 106. The hard drive interface 132 interfaces with a hard drive 134. In a preferred embodiment, the hard drive 134 communicates with system memory 136, which is also coupled to the system bus 106. System memory is defined as a lowest level of volatile memory in the computer 100. This volatile memory includes additional higher levels of volatile memory (not shown), including, but not limited to, cache memory, registers and buffers. Data that populates the system memory 136 includes the operating system (OS) 138 and application programs 144.

The operating system 138 includes a shell 140 for providing transparent user access to resources such as application programs 144. Generally, the shell 140 is a program that provides an interpreter and an interface between the user and the operating system. More specifically, the shell 140 executes commands that are entered into a command line user interface or from a file. Thus, the shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while the shell 140 may be a text-based, line-oriented user interface, other embodiments may support other user interface modes, such as graphical, voice, gestural, etc.

As depicted, the operating system 138 also includes the kernel 142, which includes lower levels of functionality for the operating system 138, including providing essential services required by other parts of the operating system 138 and application programs 144. Such essential services may include memory management, process and task management, disk management, and mouse and keyboard management. As shown, the computer 100 includes application programs 144 in the system memory of the computer 100, including, without limitation, the SAN manager logic 48, which may be used to implement one or more of the embodiments disclosed herein.

The hardware elements depicted in the computer 100 are not intended to be exhaustive, but rather are representative. For instance, the computer 100 may include alternate memory storage devices such as magnetic cassettes, digital versatile disks (DVDs), Bernoulli cartridges, and the like. These and other variations are intended to be within the scope of the present invention.

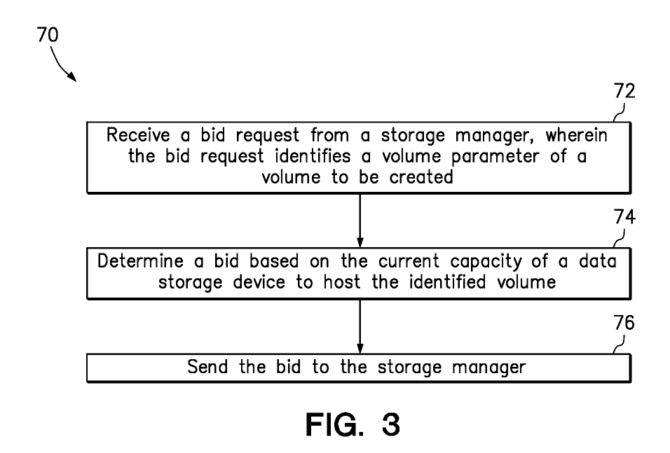

FIG. 3 is a flowchart of actions 70 taken by a processor for a data storage device executing program instructions according to one embodiment. In action 72, the processor receives a bid request from a storage manager, wherein the bid request identifies a volume parameter of a volume to be created. In action 74, the processor determines a bid based on the current capacity of a data storage device to host the identified volume. In action 76, the processor sends the bid to the storage manager.

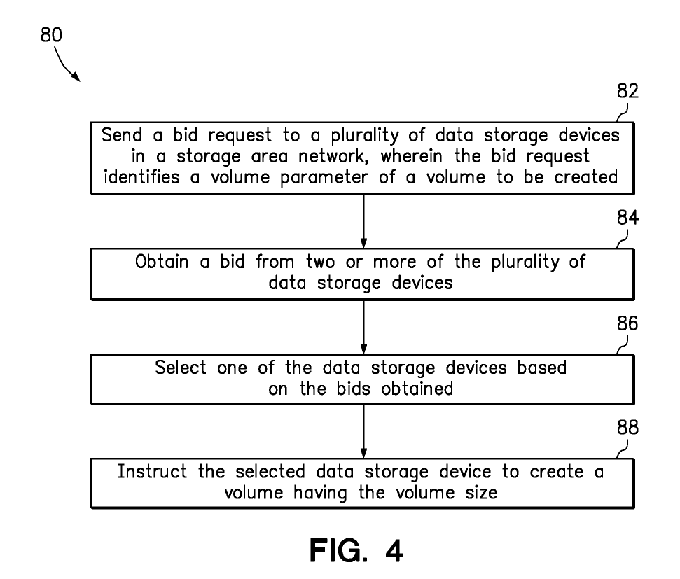

FIG. 4 is a flowchart of actions 80 taken by a processor for a storage management device executing program instructions according to one embodiment. In action 82, the processor sends a bid request to a plurality of data storage devices in a storage area network, wherein the bid request identifies a volume parameter of a volume to be created. In action 84, the processor obtains a bid from two or more of the of data storage devices. In action 86, the processor selects one of the data storage devices based on the bids obtained. In action 88, the processor instruct the selected data storage device to create a volume having the volume parameter.

As will be appreciated by one skilled in the art, embodiments may take the form of a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Furthermore, any program instruction or code that is embodied on such computer readable storage media (including forms referred to as volatile memory) that is not a transitory signal are, for the avoidance of doubt, considered “non-transitory”.

Program code embodied on a computer readable storage medium may be transmitted using any appropriate medium, including but not limited to wireless, wireline, optical fiber cable, RF, etc., or any suitable combination of the foregoing. Computer program code for carrying out various operations may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments may be described with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored on computer readable storage media is not a transitory signal, such that the program instructions can direct a computer, other programmable data processing apparatus, or other devices to function in a particular manner, and such that the program instructions stored in the computer readable storage medium produce an article of manufacture.

The computer program instructions may also be loaded onto a computer, other programmable data processing apparatus, or other devices to perform a series of operational steps on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but it is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

What is claimed is:

1. A computer program product comprising computer readable storage medium that is not a transitory signal having program instructions embodied therewith, the program instructions executable by a processor to:
receive a bid request from a storage manager, wherein the bid request identifies a volume parameter of a volume to be created;
determine a bid based on the current capacity of a data storage device to host the identified volume; and
send the bid to the storage manager.

2. The computer program product of claim 1, wherein the program instructions are further executable by the processor to:
receive an instruction to create a volume with the identified volume parameter; and
create the volume having the identified volume parameter.

3. The computer program product of claim 1, wherein the volume parameter is selected from the group consisting of a volume size and an input/output load.

4. The computer program product of claim 1, wherein the program instructions executable by a processor to determine a bid based on the current capacity of a first data storage device to host the identified volume, include program instructions executable by a processor to determine the bid as a function of one or more of an amount of available data storage capacity within the first data storage device, an input/output load on the first data storage device, and a load on a central processing unit of the first data storage device.

5. The computer program product of claim 1, wherein the program instructions executable by a processor to determine a bid based on the current capacity of a first data storage device to host the volume with the identified volume parameter, include program instructions executable by a processor to determine the bid as a function of both an amount of available data storage capacity within the first data storage device and an amount of available input/output capacity on the first data storage device.

6. The computer program product of claim 5, wherein the bid request further identifies a quality of service requirement to be considered in determining a bid.

7. The computer program product of claim 1, wherein the bid is a numerical value in a predetermined range.

8. An apparatus, comprising:
at least one storage device for storing program instructions; and
at least one processor for processing the program instructions to:
receive a bid request from a storage manager, wherein the bid request identifies a volume parameter of a volume to be created;
determine a bid based on the current capacity of a data storage device to host the identified volume; and
send the bid to the storage manager.

9. The apparatus of claim 8, the at least one processor for further processing the program instructions to:
receive an instruction to create a volume with the identified volume parameter; and
create the volume having the identified volume parameter on the data storage device.

10. The apparatus of claim 8, wherein the volume parameter is selected from the group consisting of a volume size and an input/output load.

11. The apparatus of claim 8, wherein processing the program instructions to determine a bid based on the current capacity of a first data storage device to host the identified volume, includes processing the program instructions to determine the bid as a function of one or more of an amount of available data storage capacity within the first data storage device, an input/output load on the first data storage device, and a load on a central processing unit of the first data storage device.

12. The apparatus of claim 8, wherein processing the program instructions to determine a bid based on the current capacity of a first data storage device to host the identified volume, includes processing the program instructions to determine the bid as a function of both an amount of available data storage capacity within the first data storage device and an amount of available input/output capacity on the first data storage device.

13. The apparatus of claim 8, wherein the bid request further identifies a quality of service requirement to be considered in determining a bid.

14. The apparatus of claim 8, wherein the bid is a numerical value in a predetermined range.

15. A computer program product comprising computer readable storage medium that is not a transitory signal having program instructions embodied therewith, the program instructions executable by a processor to:
send a bid request to a plurality of data storage devices in a storage area network, wherein the bid request identifies a volume parameter of a volume to be created;
obtain a bid from two or more of the data storage devices;
select one of the data storage devices based on the bids obtained; and
instruct the selected data storage device to create a volume having the volume parameter.

16. The computer program product of claim 15, wherein the one of the data storage devices is selected in response to obtaining a bid from the two or more of the plurality of programmable data storage devices.

17. The computer program product of claim 15, wherein the one of the data storage devices is selected in response to expiration of a predetermined time period following a bid request being sent to the plurality of data storage devices.

18. The computer program product of claim 15, wherein the program instructions are further executable by the processor to:
instruct a second data storage device to migrate an existing volume to the selected data storage device.

19. The computer program product of claim 15, wherein the volume parameter is selected from the group consisting of a volume size and an input/output load.
